(19) United States
(12) Patent Application Publication
(10) Pub. No.: US 2003/0008059 A1
(43) Pub. Date: Jan. 9, 2003

(54) Foamed dried beverage powder

(76) Inventors: William Michael Macinnes, Lausanne (CH); Friedrich Witschi, Brutten (CH); Erich J. Windhab, Hemishofen (CH)

Correspondence Address: WINSTON & STRAWN, PATENT DEPARTMENT, 1400 L STREET, N.W., WASHINGTON, DC, 20005-3502, US

(21) Appl. No.: 10/225,681

(22) Filed: Aug. 21, 2002

Related U.S. Application Data
(63) Continuation of application No. PCT/EP01/02814, filed on Mar. 13, 2001.

(30) Foreign Application Priority Data
Mar. 15, 2000 (EP) 00105523.5

(51) Int. Cl. C12C 1/00

(52) U.S. Cl. 426/590

(57) ABSTRACT

The invention concerns a process for preparing a dried soluble beverage product from beverage liquor. The process includes preparing a concentrated beverage liquor to provide a concentrated liquor of a solids concentration above about 50% by weight; foaming the concentrated liquor to an overrun of at least about 200% for providing a foamed liquor; stabilizing the foamed liquor for providing a stabilized foam; and drying the stabilized foam for providing a soluble beverage product. The invention also relates to a dried beverage product of particles of a dried beverage base. The particles have a clearly identifiable foam structure that is substantially free from structures produced by ice crystals during in the drying of the product.

### CROSS-REFERENCE TO RELATED APPLICATION

This application is a continuation of the U.S. national stage designation of International Application PCT/EP01/02814 filed Mar. 13, 2001, the content of which is expressly incorporated herein by reference thereto.

### FIELD OF THE INVENTION

This invention relates to a process for preparing a dried soluble beverage product and to the dried beverage product produced thereby. The process is particularly suitable for producing beverage powders which contain high levels of carbohydrates and/or polysaccharides and which have high levels of overrun.

### BACKGROUND ART

Many soluble beverage powders are commercially available. Examples of these powders include soluble coffee powder, soluble tea powder, milk powders, cereal-based beverage powders, and chocolate-based powders. These beverage powders are usually produced by spray-drying or freeze-drying a concentrated base liquor. Normally, the base liquor has a solids concentration of about 20% to about 40% by weight.

The concentrated liquor is usually dried by spraying the concentrated liquor into a drying tower along with a drying gas; usually hot air. The air temperature and air flow rates are adjusted to give a desired level of moisture in the spray-dried beverage powder that is produced. Usually, this moisture level is selected to be less than about 10% by weight.

The concentrated liquor can also be usually freeze dried by first chilling the concentrated liquor to a slush and then gassing it. The gassed liquor frozen and then comminuted to particles. The particles are transferred to a vacuum dryer where frozen water in the particles is caused to sublime. Again, the final moisture level is usually selected to be less than about 10% by weight.

Both spray-drying and freeze-drying are expensive unit operations, with freeze drying being even more expensive than spray drying. Therefore, attempts have been made to avoid spray- or freeze-drying. Usually, these attempts have based on a first step of concentrating the base liquor to very high solids concentrations; for example over about 80% by weight. Next, the concentrated base liquor is heated and pressurised before being allowed to expand. A certain amount of moisture is lost during the expansion. Thereafter, the concentrate is chilled, comminuted and, if necessary, subjected to further drying.

An example of such a process is described in U.S. Pat. No. 5,079,026 in relation to the production of soluble coffee beverages. Unfortunately, these processes result in the formation of carbohydrate glasses which can cause the resulting powder to be much less soluble than spray- or freeze-dried powders. This is acknowledged in U.S. Pat. No. 5,079,026 where it is stated that oil should be injected into the concentrated base liquor to improve solubility.

Therefore there remains a need for a process of drying beverage liquors to powder without the need for spray- or freeze-drying unit operations. The present invention now provides such a process.

### SUMMARY OF THE INVENTION

Accordingly, in one aspect, the invention provides a process for preparing a dried soluble beverage product from a beverage liquor, which comprises:

providing a concentrated beverage liquor having a solids concentration that is above about 50% by weight;

providing a foamed liquor by foaming the concentrated beverage liquor to an overrun of at least about 200%;

providing a stabilized foam by stabilizing the foamed liquor; and

providing a dried soluble beverage product by drying the stabilized foam.

It is surprisingly found that this process is able to produce a beverage product that has good solubility and at a reduced operating cost. The process allows a rapid drying of the beverage product.

Preparation of the beverage liquor may preferably be done by concentrating a liquor to provide a concentrated liquor of a solids concentration above 50%, preferably in the range from about 60% to about 85%, and more preferably in the range of from about 70% to about 85% solids by weight. Alternatively, the preparation of the concentrated beverage liquor may preferably be done by reconstituting previously dried beverage powders or mixes of powders and liquids, by adding a liquid such as water to the above-mentioned desired solids concentrations.

The concentrated liquor is foamed to an overrun of at least 200%, preferably foamed to an overrun in the range of from about 250% to about 500%, more preferably above about 300% and most preferably in the range from about 350% to about 500% overrun. The actual overrun used will depend on the desired final bulk density of the dry powder. Foams with these levels of overrun will have bubble sizes of about 5 μm to about 200 μm in diameter.

The foamed liquor is preferably stabilized by rapidly chilling it; for example to a temperature below about 0° C. within several minutes and maintained at the stabilising temperature until drying begins. The preferable cooling time can range from 1 minute to 30 minutes depending on the final necessary temperature for foam stabilisation and on the foam overrun, i.e., its thermal conductivity. The preferable range of final stabilized foam temperatures can range from about −40° C. to about 40° C. depending on the solids content of the foam liquor and its viscosity at those temperatures. It is desirable that the final stabilising temperature is such that the liquor viscosity is >10⁵ Pa.sec and preferably between about 10⁶ and about 10⁸ Pa.sec. This is important to get a sufficiently stabilized foam, which does not collapse prior to drying. Therefore, for a specific liquor and solids content an appropriate temperature for stabilising the foam can be determined knowing the position of the constant viscosity or “iso-viscosity” line which specifies the temperatures as a function of solids content where the viscosity is equal to 10⁵ Pa.sec, for example. The iso-viscosity lines can be defined in the product's state diagram and are usually “parallel” to the product's glass transition line.

In a another aspect, this invention provides a soluble beverage powder or dry shaped particles produced by forming or moulding during the stabilisation phase of the process defined above.

In further aspect, this invention provides a soluble foamed beverage product or powder, or dry shaped particles comprising particles of a dried beverage base, the particles having a clearly identifiable foam structure which is substantially free from structures produced by ice crystals during in the drying of the product.

It has been found that the soluble beverage powder, due to controlled porosity, has an improved solubility. In common with the particles of beverage powders produced by freeze-drying process the particles of this invention are substantially homogeneous in relation to their density.

The soluble beverage product may be a polysaccharide powder, for example, a soluble coffee powder, a soluble tea powder, or a powder with a large percentage of low molecular weight sugars, carbohydrates and other ingredients such as a soluble milk powder, a cereal-based beverage powder, or a chocolate beverage powder.

### BRIEF DESCRIPTION OF THE DRAWING FIGURES

The soluble beverage product of the invention will now be further illustrated by way of examples only with reference to the drawings in which:

FIG. 1 is a photographs of beverage product according to the invention gassed with CO₂,

FIG. 2 is a photographs of beverage product according to the invention gassed with N₂,

FIG. 3 is a photographs of a freezer dried beverage product, and

FIG. 4 is a photographs of a non-agglomerated spray dried beverage product.

### DETAILED DESCRIPTION OF PREFERRED EMBODIMENTS

Preferred embodiments of the invention are now described by way of example only to further illustrate the features and benefits of the invention.

In this specification, the term “overrun” means the ratio of the weight of a given volume of liquor minus the weight of the same volume of foam, divided by the weight of foam of the same volume, expressed as %.

$$O v e r r u n = \frac{( {W}_{l i q u o r} - {W}_{f o a m} )}{{W}_{f o a m}} 100$$

In the present context “stabilizing a foam” means that the foam is made rigid enough so that it will not collapse under its own weight at least for a period of time up to and including the drying time. Advantageously, the foam should be substantially stable until it is dried. For practical purposes, this is from about one minute, if drying starts immediately after the foam production and stabilization step, up to several hours if the drying operation must be delayed for example in a batch drying sequence. It is preferred that the foam be stable for at least about one or two minutes.

The invention provides beverage powder that is made up of particles or dried shapes having a unique internal texture and which are soluble. The beverage product is produced by a process which comprises foaming highly concentrated beverage liquors to high overruns. The foamed liquors are then dried but they need much less drying than less concentrated liquors. Therefore the operational costs associated with drying may be reduced, and less expensive techniques than vacuum drying or freeze-drying can be used.

The invention may be used in relation to any beverage powder which contains carbohydrates or polysaccharides. Examples of suitable beverage powders are given above. However, for simplicity, the invention will be described primarily in relation to the production of soluble coffee powder. It is to be appreciated that the invention is in no way limited to the production of soluble coffee powder.

One of the initial steps in the process is the preparation of a concentrated beverage liquor. The beverage liquor may be obtained from any suitable source. For example, it may be obtained by mixing previously dried powders with water to obtain a concentrated liquor, or a liquor which can then be further concentrated, if needed or desired.

For example, in the case of coffee, a coffee extract may be prepared in the usual fashion. For example, a coffee extract is prepared by subjecting roast and ground coffee to extraction using an extraction liquid. The extraction liquid may be hot water or a hot, dilute coffee extract.

The extraction may be carried out in a counter-current manner in one or more extraction vessels. Any suitable extraction vessel may be used; for example fixed bed reactors or continuous counter-current extractors. The choice and design of the vessels is a matter of preference and has no critical impact on the process. Further, if fixed bed reactors are used, the extraction liquid may be caused to flow upward through the reactor or downward through the reactor, as desired. However, the extraction is conveniently carried out in a battery of fixed bed reactors connected such that extraction liquid may flow through them in series.

The extraction may be carried out under any desired conditions, which provide a desired yield and flavor profile. The extraction conditions are not critical to the process. Suitable extraction processes and conditions are described in U.S. Pat. Nos. 5,242,700 and 5,897,903, the entire disclosures of each of which are incorporated herein by reference thereto.

The extract thus obtained is then concentrated by suitable means. For example, the extract may be concentrated in film evaporators. Thin film evaporators are particularly suitable; such as the evaporators commercialized by Luwa AG of Zürich, Switzerland. Otherwise plate evaporators or other suitable equipment may be used. The extract is concentrated to a solids concentration of about 50% to about 85% by weight; preferably above 60% and more preferably in the range of 70% to 85% solids by weight. Extracts of this concentration are extremely viscous at room temperature.

The concentrated extract is then subjected to foaming. In order for the final product to be sufficiently soluble and easily and economically dried, the concentrated extract should be foamed to an overrun of at least 200%. For example, the concentrated extract may be preferably foamed to an overrun that is above 250% and more preferably in the range of 350% to 500% overrun. The actual overrun used will depend on the desired final bulk density of the dry powder. The foaming is best carried out by mechanical means. In order to obtain the above-mentioned level of foaming in a concentrated extract containing at least 50% by weight of solids, the foaming is best carried out at above room temperature and at a high pressure in a rotor/stator foam processor. The preferable range of temperatures depends on the solids content of the liquor and its viscosity, and generally will be in the range of 20° C. to 120° C. The preferable range of pressures for foaming will depend on the final overrun and bubble size that is desired, and generally will be in the range of 1 to 60 bars (0.1 MPa to 6 MPa) pressure. A preferred temperature range is from about 40° C. to about 80° C. and a preferred pressure range is from about 0.5 to 4 Mpa.

Foam processors of this nature are commercially available. Suitable foam processors may be obtained from Kinematica AG of Lucerne, Switzerland under the trade name MEGATRON. The foam processor internal geometry comprises a tubular stator, which has a set of teeth in its bore. The rotor, which rotates in the bore of the stator, has a complementary set of teeth. The gap between the teeth of the rotor and those of the stator can be set in the range of 0.1 mm to 5 mm. Another feature of this foam processor is the small internal volume and good cooling of the foam that is achieved due to a surrounding cooling jacket, which minimizes the specific mechanical energy required for foaming, and limits the temperature rise in the foam during the foaming step.

A foaming gas is injected into the concentrated extract, which then passes into the high shear field generated between the teeth of the rotor and stator. The concentrated extract is then highly foamed with the foam being formed of bubbles of size less than about 200 μm, at atmospheric pressure; the bubble size in the foam processor will be smaller by the ratio of the pressure in the foam processor to atmospheric pressure. For example, if the bubble size after expansion is 100μm, and the foaming pressure is 25 bars, the foam bubble size generated in the foam processor will be 4 μm.

The foaming gas that is used to foam the concentrated extract may be any suitable gas; for example air, nitrogen and carbon dioxide. For beverage powders, which are damaged by oxygen, inert gases such as nitrogen and carbon dioxide are preferred. The foam bubble size also depends on the gas used. Nitrogen gas results in much smaller bubble size than carbon dioxide gas, and mixtures of these gases can be used to control bubble size. Similarly, the thermal conductivity in the foam depends on the gas used; it may be improved by using a low molecular weight gas such as helium.

The foam processor is preferably operated at pressures above atmospheric pressure, at least at 0.1 Mpa, and preferably above 0.2 Mpa. More preferably the pressure is in the range of 0.5 to 4 Mpa.

It has been found that the foam may be treated in a manner usual for soluble powder production. Thus, if desired, it is possible to form the foamed extract into thin sheets, strips or rods prior to and/or during the cooling and stabilizing operations on the foam. This will facilitate later comminuting operations, if these are necessary. This is conveniently done by forcing the foamed extract through a suitable orifice; for example an extrusion die. The thin sheets, strips or rods preferably have dimensions close to the desired final soluble powder particle dimensions that is, in a range of 0.1 to 4 mm and preferably in a range of 1 to 3 mm.

Before drying, the foamed extract is then stabilized to a sufficiently rigid state, so that it can be further processed and in particular, dried successfully without losing the unique internal foam texture/structure and the desired porosity/overrun that were generated during the foaming operation. This is conveniently done by rapidly cooling the foamed extract, for example, within about 1 to 30 minutes. This may be done by transporting the foam onto a freezing drum or belt cooled used a suitable cooling medium. Freezing systems conventionally used in freeze-drying operations instead may be used. Conventional cooling means include cold air or liquid refrigerants such as ammonia, liquid carbon dioxide, or other refrigerants preferably with low ozone producing levels.

Alternatively, the foamed extract may be quenched in a suitable liquid cooling medium. If the beverage product is cooled by direct contact with a liquid, then the cooling medium will preferably be liquid nitrogen, liquid carbon dioxide, or cold ethanol and the like. In this case, the cooling may be sufficiently rapid such that the foam temperature is reduced to its final stabilized foam temperature within 0.1 to 1 minutes. The preferable range of final stabilized foam temperatures can range from about −40° C. to 40° C. depending on the solids content of the foam liquor and its viscosity at those temperatures. The final stabilizing temperature must be such that the liquor viscosity is >10⁵ Pa.sec and preferably >10⁶ to 10⁸Pa.sec. For the production of soluble coffee, a more preferred range of final stabilisation foam temperature is from about −40° C. to 0° C., for concentrated extract or foam solids content equal to 70% up to 80%, as defined by the iso-viscosity=10⁵ Pa.sec line in the coffee liquor state diagram..

Suitable stabilizers may also be added to the liquor or foam to stabilize or assist in stabilizing it. Food-grade surfactants or proteins that have this functionality can be used for this purpose. The stabilizers are conveniently added to the concentrated extract immediately prior to foaming.

The foam may also be stabilized by incorporation of specific “gel-forming” polysaccharides therein. Examples of suitable “gel-forming” polysaccharides are gelatine, agar agar, guar gum, pectins and the like which will, upon gelation in the foam, enhance its rigidity. These gelling agents may also be added to assist the stabilization process described above.

The foams may also be stabilized by incorporation of specific “crystallizing” carbohydrates. Suitable “crystallizing” carbohydrates include lactose, mannitol, and the like which will, upon crystallization in the foam, enhance its rigidity. The crystallizing agent may also be added to assist the stabilization process described above.

Contrary to other processes involving high solids content liquors, there is substantially no “flashing”, i.e., instantaneous boiling or vaporization of water. Instead, water loss occurs at the discharge of the pressure reducing device upon the exit from the foam processor. This is because temperature of the foam is rather low, i.e., below the boiling point of water due to the low entry temperature, the low specific mechanical energy for foaming, and the good cooling in the Kinematica foam processor. Never-the-less, due to the high solids content of the extract and foam produced in the process described above, the amount of moisture that must be removed in subsequent drying steps is much reduced as compared to spray- and freeze-drying.

The stabilized foam may then be subjected to comminuting. This may be accomplished by breaking the foam into pieces of a relative large size and then grinding the pieces to smaller sizes. The unit operations conventionally used to break up frozen concentrate in freeze-drying operations may also be used to comminute the stabilized foam. The stabilized foam is preferably comminuted to a particle size of about 0.5 mm to about 3 mm and more preferably to a size of from 1 to 2.5 mm.

Alternatively, the stabilized foamed liquor may be subjected a forming step wherein it is formed into particles or specific shapes prior to or during the stabilization. For example, by forcing or extruding the foamed liquor through a nozzle or extrusion die, using the pressure in the foam processor. The foamed liquor may also be formed by molding prior to, or during, the stabilization process into a specific shape or shapes that is retained in the final dried product. Common injection molding techniques may be used.

The particles or shapes are then dried. Due to the high initial solids content of the concentrated liquor, the amount of water that must be removed during the drying step has been very significantly reduced. This may result in a significant reduction in drying unit operation costs, as well as making possible the use of less expensive techniques than vacuum drying or freeze-drying. Drying may be done in any suitable manner in any suitable drier, but it is desirable that in drying to soluble product, the particles or shapes should substantially retain their unique internal foam texture/structure and the porosity and overrun that were generated during the foaming operation. The bubble size and overrun as well as the controlled porosity generated during the foaming and stabilizing processes described above aid substantially in the efficiency of the drying operations.

The porosity can be controlled by the overrun and cooling rate of the foam; with quench cooling leading to more open or interconnected bubble porosity than does slower cooling. For example, the particles may be dried in a vacuum drier. Suitable vacuum dryers are commercially available. Further, vacuum dryers which are conventionally used in freeze-drying operations also may be used.

Alternatively, the particles may be dried in a fluidized bed drier. For dryers which do not operate under reduced pressure, it may be advantageous to begin drying at a temperature below the glass transition temperature of the particles. The drying temperature may then be raised as the glass transition temperature of the particles increases with drying. This may substantially eliminate collapsing of the foamed particles during drying.

Alternatively, the particles may be dried in a hot air tunnel drier, on a wire mesh belt. Here again, the drying temperature must be controlled to avoid the collapse of the foamed particles during drying.

The particles obtained from the drier may then be allowed to cool and are then processed and packed in the usual manner.

In the production of soluble coffee powders, it is also found that the foaming gas and the extent of foaming has an influence on the appearance of the powder. For example, if the foaming gas is carbon dioxide and an overrun of 300% to 400% is used, a darker powder is obtained. However, if the foaming gas is nitrogen and an overrun of 400% to 500% is used, a lighter powder is obtained. This enables powders of a desired appearance to be produced. In general, the powders of this invention can have an appearance, to the naked eye, which is substantially identical to powders produced by freeze-drying. Powders of a desired density of about 220 kg/m³ to about 250 kg/m³ may be obtained.

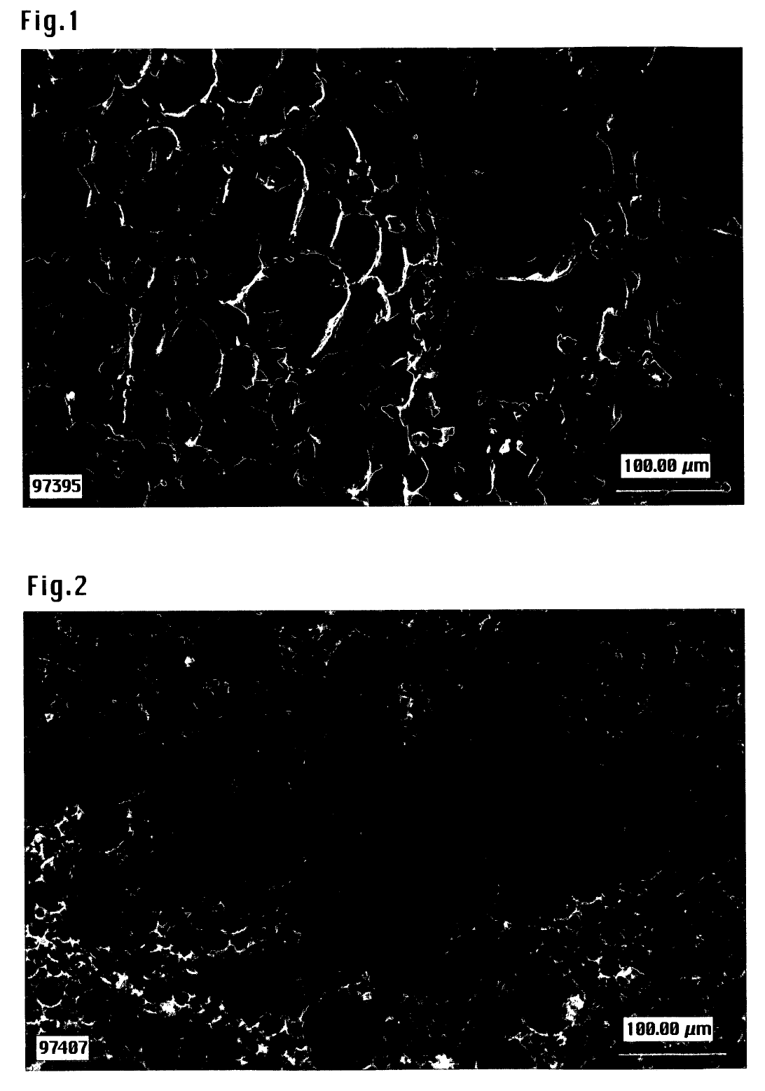

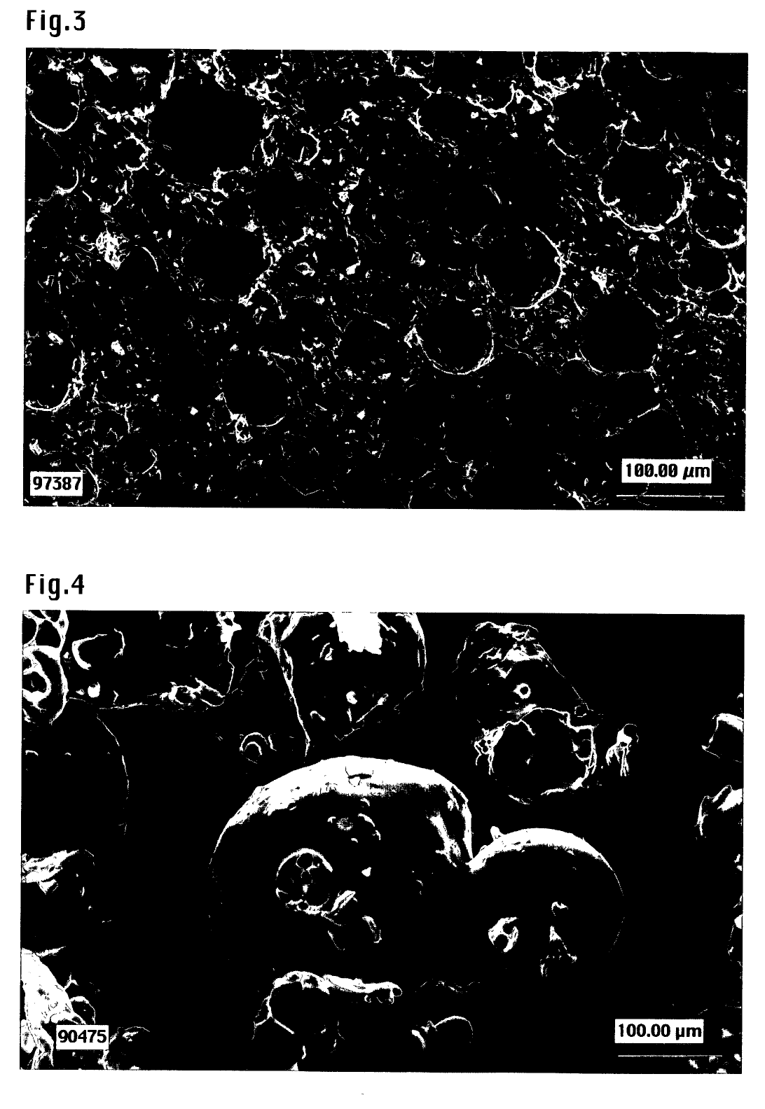

FIG. 1 shows a soluble beverage product according to the invention which has an overrun of 540% and which has been gassed with CO₂. In FIG. 2 the soluble beverage product according to the invention has an overrun of 470%.

It can be seen from the FIGS. 1 and 2 that the soluble beverage product of the invention comprises particles of a dried beverage base, each particle having a substantially foamed structure with a minimum of structure of ice crystals which are usually produced during the freezing-drying process, at the microscopic scale (magnification of >20×).

Further it can be seen that the soluble beverage powder of the invention comprises particles of a dried beverage base, each particle having a clearly identifiable foam structure which is substantially homogeneous in relation to its density.

It has been found that the beverage product according to the invention has a unique easily identifiable structure. Examples of this foam structure and texture are shown in the Scanning Electron Microscope photographs for comparison to those structure generated by spray-drying and freeze-drying. It is clearly seen that the internal particle structure and texture of the beverage product according to the invention is significantly different from and distinguishable from than that produced by spray-drying or freeze-drying. For the beverage product according to the invention the particles internal structure and texture with its controlled porosity and overrun forms the basis for the rapid drying with reduced costs, and for the good solubility of the dry powder

What is claimed is:

1. A process for preparing a dried soluble beverage product from a beverage liquor, which comprises:
providing a concentrated beverage liquor having a solids concentration that is above about 50% by weight;
providing a foamed liquor by foaming the concentrated beverage liquor to an overrun of at least about 200%;
providing a stabilized foam by stabilizing the foamed liquor; and
providing a dried soluble beverage product by drying the stabilized foam.

2. The process according to claim 1, in which the stabilized foam is comminuted to particles and the particles are dried to form the soluble beverage powder.

3. The process according to claim 1, in which the foamed liquor is formed into particles or specific shapes prior to or during the stabilizing step.

4. The process according to claim 1, in which, prior to or during the stabilization step, the foamed liquor is formed by molding process into one or more specific shapes that are retained in the final dried product.

5. The process according to claim 1, in which the concentrated beverage liquor is prepared by concentrating a solids liquor to a solids concentration of about 60% to about 85% by weight.

6. The process according to claim 1, in which the beverage liquor is prepared by mixing ingredients in powder or liquid state with water to provide a concentrated liquor having a solids concentration of about 60% to about 85% by weight.

7. The process according to claim 1, in which the concentrated liquor is foamed to an overrun of about 250% to about 500%.

8. The process according to claim 1, in which the foamed liquor is stabilized by being rapidly chilled.

9. The process according to claim 1, in which the foamed liquor is stabilized by incorporation of a foam stabilizing ingredient therein.

10. The process according to claim 9, in which the foamed liquor is stabilized by incorporation of a gelling agent therein.

11. The process according to claim 10 in which the foamed liquor is stabilized by incorporation of a crystallising agent therein.

12. A soluble foamed beverage product prepared by the process of claim 1.

13. A soluble foamed beverage product comprising particles of a dried beverage base, the particles having a clearly identifiable foam structure that is substantially free from structures produced by ice crystals that would form during drying of the product.

14. The soluble foamed beverage product according to claim 13, comprising particles of a dried beverage base, with each particle having a clearly identifiable foam structure which is substantially homogeneous in relation to its density.

15. The soluble foamed beverage product according to claim 13, comprising particles or shapes of a dried beverage base selected from the group consisting of coffee, tea, milk, cereals, chocolate, carbohydrates, polysaccharides or a combination thereof.

16. The soluble foamed beverage product according to claim 13, having a density of about 220 kg/m³ to about 250 kg/m³ and a particle size of between about 0.1 to 4 mm.
